(19) United States
(12) Patent Application Publication
(10) Pub. No.: US 2026/0019556 A1
(43) Pub. Date: Jan. 15, 2026

(54) DISPLAY METHOD AND APPARATUS BASED ON VIRTUAL REALITY, ELECTRONIC DEVICE, AND STORAGE MEDIUM

(71) Applicant: Beijing Zitiao Network Technology Co., Ltd., Beijing (CN)

(72) Inventor: Xiuxiang HU, Beijing (CN)

(21) Appl. No.: 19/266,688

(22) Filed: Jul. 11, 2025

(30) Foreign Application Priority Data
Jul. 11, 2024 (CN) 202410931381.9

(51) Int. Cl. H04N 13/398; H04N 13/189; H04N 13/383

(52) U.S. Cl. CPC H04N 13/398; H04N 13/189; H04N 13/383

(57) ABSTRACT

The present disclosure provides a display method and apparatus based on virtual reality, an electronic device, and a storage medium. The display method based on virtual reality includes: displaying a main scene in a three-dimensional virtual reality world and displaying a target window in the main scene, the main scene is an application scene of a first application displayed in full screen, an application scene of a second application is displayed in the target window, and the first application and the second application are different; obtaining display reference data in the main scene and sharing the display reference data in the main scene for the second application; and controlling an application scene viewpoint of the main scene and an application scene viewpoint of the target window to be both consistent with a viewpoint of a current user according to the display reference data in the main scene.

### CROSS-REFERENCE TO RELATED APPLICATION

The present application claims priority of the Chinese Patent Application No. 202410931381.9, filed on Jul. 11, 2024, the disclosure of which is incorporated herein by reference in the present application.

### TECHNICAL FIELD

The present disclosure relates to the technical field of virtual reality, and in particular, to a display method and apparatus based on virtual reality, an electronic device, and a storage medium.

### BACKGROUND

A virtual reality device is device for realizing display with the virtual reality technology. Usually, the virtual reality device includes a headset and a handle serving as a controller. Interaction requirements are usually met by operations through the handle and a virtual interface in the headset.

### SUMMARY

The present disclosure provides a display method and apparatus based on virtual reality, an electronic device, and a storage medium.

The present disclosure adopts the following technical solutions.

In some embodiments, the present disclosure provides a display method based on virtual reality, including:
displaying a main scene in a three-dimensional virtual reality world and displaying a target window in the main scene, the main scene is an application scene of a first application displayed in full screen, an application scene of a second application is displayed in the target window, and the first application and the second application are different;
obtaining display reference data in the main scene and sharing the display reference data in the main scene for the second application; and
controlling an application scene viewpoint of the main scene and an application scene viewpoint of the target window to be both consistent with a viewpoint of a current user according to the display reference data in the main scene.

In some embodiments, the present disclosure provides a display apparatus based on virtual reality, including:
a display unit configured to display a main scene in a three-dimensional virtual reality world, and display a target window in the main scene, the main scene is an application scene of a first application displayed in full screen, an application scene of a second application is displayed in the target window, and the first application and the second application are different; and
a control unit configured to obtain display reference data in the main scene, and share the display reference data in the main scene for the second application;
the control unit is further configured to control an application scene viewpoint of the main scene and an application scene viewpoint of the target window to be both consistent with a viewpoint of a current user according to the display reference data in the main scene.

In some embodiments, the present disclosure provides an electronic device, including: at least one memory and at least one processor;

the at least one memory is configured to store program codes, and the at least one processor is configured to call the program codes stored on the at least one memory to perform the above-mentioned method.

In some embodiments, the present disclosure provides a computer-readable storage medium, configured to store program codes which, when run by a processor, cause the processor to perform the above-mentioned method.

### BRIEF DESCRIPTION OF DRAWINGS

The above and other features, advantages, and aspects of each embodiment of the present disclosure may become more apparent by combining drawings and referring to the following specific implementation modes. In the drawings throughout, same or similar drawing reference signs represent same or similar elements. It should be understood that the drawings are schematic, and originals and elements may not necessarily be drawn to scale.

FIG. 1 is a schematic diagram of using a virtual reality device according to an embodiment of the present disclosure;

FIG. 2 is an optional schematic diagram of a virtual field of view of a virtual reality device provided according to an embodiment of the present disclosure;

FIG. 3 is a flowchart of a display method based on virtual reality according to an embodiment of the present disclosure; and

FIG. 4 is a structural schematic diagram of an electronic device according to an embodiment of the present disclosure.

### DETAILED DESCRIPTION

It is to be understood that before using the technical solutions disclosed in each embodiment of the present disclosure, it is needed to inform the type, scope of use, and use scenes, etc. of the personal information involved in the present disclosure to a user and gain the authorization of the user through appropriate methods in accordance with relevant laws and regulations.

For example, when transmitting prompt information to the user in response to an active request of the user so as to clearly prompt the user, the operation requested to be executed needs to gain and use the personal information of the user. Therefore, the user can autonomously select whether to provide personal information for software or hardware such as an electronic device, an application, a server or a storage medium executing the operation of the technical solution of the present disclosure according to the prompt information.

As an optional but non-limited implementation mode, the mode of transmitting the prompt information to the user in response to receiving the active request of the user can be a popup window mode, and the prompt information can be presented in a character mode in the popup window. In addition, the popup window can also carry a selection control for the user to select “Agree” or “Disagree” to provide personal information for the electronic device.

It is to be understood that the above-mentioned processing of informing and gaining the authorization of the user is only indicative and do not limit the implementation mode of the present disclosure, and other modes that meet the relevant laws and regulations can also be applied to the implementation mode of the present disclosure.

It is to be understood that data involved in this technical solution (including but not limited to the data itself, acquisition or use of data) shall comply with the requirements of relevant laws and regulations and relevant provisions.

Embodiments of the present disclosure are described in more detail below with reference to the drawings. Although certain embodiments of the present disclosure are shown in the drawings, it should be understood that the present disclosure may be achieved in various forms and should not be construed as being limited to the embodiments described here. On the contrary, these embodiments are provided to understand the present disclosure more clearly and completely. It should be understood that the drawings and the embodiments of the present disclosure are only for exemplary purposes and are not intended to limit the scope of protection of the present disclosure.

It should be understood that various steps recorded in the implementation modes of the method of the present disclosure may be performed according to different orders and/or performed in parallel. In addition, the implementation modes of the method may include additional steps and/or steps omitted or unshown. The scope of the present disclosure is not limited in this aspect.

The term “including” and its variations thereof used in this article are open-ended inclusion, namely “including but not limited to”. The term “based on” refers to “at least partially based on”. The term “one embodiment” means “at least one embodiment”; the term “another embodiment” means “at least one other embodiment”; and the term “some embodiments” means “at least some embodiments”. Relevant definitions of other terms may be given in the description hereinafter.

It should be noted that concepts such as “first” and “second” mentioned in the present disclosure are only used to distinguish different apparatuses, modules or units, and are not intended to limit orders or interdependence relationships of functions performed by these apparatuses, modules or units.

It should be noted that modifications of “one” and “more” mentioned in the present disclosure are schematic rather than restrictive, and those skilled in the art should understand that unless otherwise explicitly stated in the context, it should be understood as “one or more”.

The names of messages or information in interaction between a plurality of apparatuses in this embodiment of present disclosure are for illustrative purposes only and are not intended to limit the scope of such messages or information.

The solution provided by the embodiments of the present disclosure is described in detail below with reference to the drawings.

According to the method provided in some embodiments of the present disclosure, in the case of displaying a plurality of applications in the virtual reality world, with the main scene in combination with the target window, the effect of rendering contents displayed in the main scene and the target window at the same viewpoint is achieved, so that viewpoints of a plurality of application scenes are consistent with that of the current user.

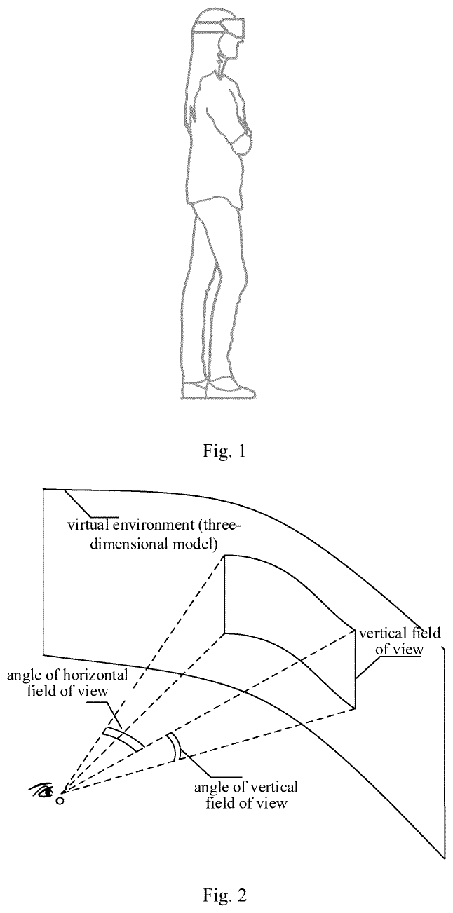

With reference to FIG. 1, a user can enter a virtual reality space by means of a virtual reality device such as a head-mounted display, or the like, and controls his/her own virtual avatar in the virtual reality space to conduct social interaction, entertainment, learning, telecommuting, and the like with virtual avatars controlled by other users.

The virtual reality device described in the embodiments of the present disclosure may include, but be not limited to, the following several types:

A personal computer virtual reality (PCVR) device, which utilizes a PC to perform related computation and data output of the virtual reality function. An external PCVR device achieves the effect of virtual reality with data output by the PC.

A mobile virtual reality device, which supports configuration of a mobile terminal (e.g., a smart phone) in various ways (e.g., a head-mounted display with a special card slot), and through wired or wireless connection with the mobile terminal, the related computation of the virtual reality function is performed by the mobile terminal and data is output to the mobile virtual reality device. For example, a virtual reality video is watched via an APP of the mobile terminal.

An all-in-one machine virtual reality device, which has a processor configured to perform the related computation of the virtual reality function and thus has independent virtual reality input and output functions, and does not need to be connected with a PC or a mobile terminal with high flexibility of use.

As a matter of course, the implementation form of the virtual reality device is not limited to the above, and the virtual reality device may be further miniaturized or enlarged as required.

A gesture detection sensor (e.g., a nine-axis sensor) is disposed in the virtual reality device, and is configured to detect a gesture change of the virtual reality device in real time. If the user wears the virtual reality device, when a head gesture of the user changes, a real-time gesture of the head is transmitted to a processor for computing a gaze point of the sight line of the user in the virtual environment. An image in a user gaze range (i.e., a virtual field of view) in a three-dimensional model of the virtual environment is computed according to the gaze point and displayed on a display screen, providing people an immersive experience as if they were watching in a real environment.

FIG. 2 illustrates an optional schematic diagram of a virtual field of view of a virtual reality device provided according to an embodiment of the present disclosure. An angle of horizontal field of view and an angle of vertical field of view are used for describing a distribution range of the virtual field of view in a virtual environment. A distribution range in a vertical direction is represented by the angle of vertical field of view BOC, and a distribution range in a horizontal direction is represented by the angle of horizontal field of view AOB. The human eyes can always perceive an image within the virtual field of view in the virtual environment through a lens. It can be understood that the larger the angle of field of view, the larger the size of the virtual field of view, and the larger the region of the virtual environment that the user can perceive. The angle of field of view represents a distribution range of viewpoints when an environment is perceived by a lens. For example, an angle of field of view of the virtual reality device represents a distribution range of viewpoints that the human eyes have when a virtual environment is perceived by a lens of the virtual reality device. For another example, for a mobile terminal with a camera, an angle of field of view of the camera represents a distribution range of viewpoints when the camera perceives a real environment for capturing.

The virtual reality device, e.g., an HMD, is integrated with a plurality of cameras (such as a depth camera and an RGB camera, etc.). The purposes of the cameras are not limited to proving pass-through views. Camera images and an integrated inertial measurement unit (IMU) provide data that may be processed by a computer vision method to automatically analyze and understand an environment. Also, the HMD is designed to not only support passive computer vision analysis, but also support active computer vision analysis. A passive computer vision method is used for analyzing image information captured from the environment. These methods may be monoscopic (images from a single camera) or stereoscopic (images from two cameras). They include, but are not limited to, feature tracking, object recognition, and depth estimation. An active computer vision method is used for adding information to the environment by projecting a pattern which is visible to a camera but not necessarily visible to the human visual system. Such techniques include a time-of-flight (ToF) camera, laser scanning, or structured light, to simplify the stereo matching problem. The active computer vision is used for realizing scene depth reconstruction.

When a virtual display device displays a virtual display world, generally, application scenes of a plurality of applications are not be displayed simultaneously. When the application scenes of the plurality of applications are displayed simultaneously, it cannot be realized that the application scene viewpoints of the application scenes of the plurality of applications are consistent with the viewpoint of a current user. In this case, the user can only use one of the applications in effect. Only after entering a specific application, the application scene viewpoint of the application scene of the application can be consistent with the viewpoint of the current user.

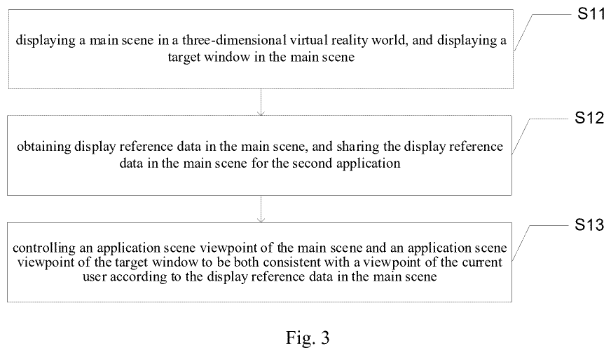

As shown in FIG. 3, FIG. 3 is a flow chart of a display method based on virtual reality according to an embodiment of the present disclosure. The display method includes the following steps.

S11, displaying a main scene in a three-dimensional virtual reality world, and displaying a target window in the main scene.

In some embodiments, an execution terminal for the display method provided in the present disclosure is a virtual reality device, e.g., a head-mounted virtual reality device. The main scene is an application scene of a first application displayed in full screen. The application scene is usually an interface displayed when the application is run. In the virtual reality world, the main scene is usually a three-dimensional application scene. In the virtual reality world, the main scene is an application scene displayed in full screen. The main scene is displayed around a current user. The first application may be any application. Usually, when an application is selected as a main application, the application scene of the application may be displayed in the main scene. The target window may be one or more windows displayed in the main scene and may have a size smaller than a size of the main scene. An application scene of a second application is displayed in the target window. The first application and the second application are different. When there are a plurality of target windows, there may be a plurality of different second applications, and each second application is displayed in one target window. Specifically, in this embodiment, the first application is selected as the main application and displayed in the main scene, while the second application is displayed in the target window. In this way, the application scenes of a plurality of applications can be displayed simultaneously in the virtual reality world, and the current user that uses the virtual reality device can see situations in the plurality of applications simultaneously.

S12, obtaining display reference data in the main scene, and sharing the display reference data in the main scene for the second application.

In some embodiments, the display reference data may be data for controlling a content displayed in the application scene. In the virtual display world, the content displayed in the application scene is usually related to the viewpoint of the current user. For example, when the current user looks in a direction in the main scene, the content in the direction needs to be drawn and presented in the virtual reality device. The application needs to obtain the display reference data when controlling the displayed application scene. A display control parameter of the main scene is the display control parameter of the first application. The display reference data in the main scene includes one or more selected from a group consisting of a camera pose in the main scene, a controller pose in the main scene, and a current user pose. A camera in the main scene is a virtual camera in the main scene. A controller is located in the main scene. The controller is, for example, a handle matching a virtual display device, which usually has a 6DOF sensor for obtaining the pose data of the controller. The current user usually wears a headset that can obtain the pose of the current user. The current user is located in the main scene, and the above-mentioned data can be obtained from the main scene.

S13, controlling an application scene viewpoint of the main scene and an application scene viewpoint of the target window to be both consistent with a viewpoint of the current user according to the display reference data in the main scene.

In some embodiments, the application scene viewpoint of the main scene may be a content in the main scene needing to be displayed. The application scene viewpoint of the target window may include a display position of the target window and/or a content displayed in the target window. In some embodiments, the content needing to be displayed is drawn for eyes of the current user by means of the virtual reality device. In terms of the main scene, the content in the direction of the sight line of the current user needs to be displayed according to the viewpoint of the current user. In terms of the target window, on the one hand, the display position of the target window may be controlled to be not fixed. The position of the target window may be always related to the viewpoint of the current user. For example, the target window may be always located within a range that can be seen by the current user, and a relative position of the target window and the sight line of the current user may be fixed. For example, the target window may be perpendicular to the sight line of the current user. In this way, the position of the presented target window may rotate with the rotation of the current user. In addition, the content presented in the target window may also change with changing of the viewpoint of the current user. For example, the application scene of the second application may be presented in the target window, but the content of the application scene presented in the target window is related to the sight line of the current user. For example, when the current user looks towards the left, the content of the left side in the main scene is displayed, and the content displayed in the target window may be the content that is displayed in the main scene when the second application is the application in the main scene. That is, the contents displayed in the main scene when the first application or the second application is the applications in the main scene may be calculated and displayed in the current main scene and the target window, respectively.

According to the display method provided in some embodiments of the present disclosure, for the case of displaying a plurality of applications in the virtual reality world, with the main scene in combination with the target window, the second application to be opened is enabled to run at background, and a real-time image is displayed in the main scene in the form of the target window. Meanwhile, the display reference data such as the camera position, the controller pose, and the current user pose in the main scene is shared to the second application. The effects of synchronously rotating, rendering at the same viewpoint, and even unified interaction of the contents displayed in the main scene and the target window can be achieved. A rendered image of the second application is generated and transferred to the target window for displaying in real time. In this way, a plurality of applications can be displayed in the main scene, and the pose of the current user and the pose data of the controller can be shared along with the motion of the current user, such that the second application displayed in the target window can also have the three-dimensional real-time effect.

In some embodiments of the present disclosure, obtaining the display reference data in the main scene and sharing the display reference data in the main scene for the second application include: saving the display reference data in the main scene to a shared directory, and obtaining the display reference data in the main scene for the second application from the shared directory.

In some embodiments, the shared directory is set. The display reference data, such as the camera pose, the controller pose, and the like, in the main scene is saved to the shared directory in real time, and the display reference data is obtained in real time from the shared directory for displaying the application scene of the second application.

In some embodiments of the present disclosure, obtaining the display reference data in the main scene for the second application from the shared directory includes: obtaining, by a runtime layer, the display reference data in the main scene from the shared directory, and replacing display reference data of the second application with the display reference data in the main scene.

In some embodiments, obtaining the display reference data is performed by the runtime layer in the system of the virtual reality device. In this way, the interface of the second application does not have any change. That is, the second application itself does not need to be modified. The second application is capable of non-inductive adaptation by replacing the display reference data of the second application.

In some embodiments of the present disclosure, an application displayed in full screen has a first-type application mark, and an application displayed in the target window has a second-type application mark; and saving the display reference data in the main scene to the shared directory, and sharing the display reference data in the main scene for the second application include: in response to presence of an application with the second-type application mark, saving display reference data of an application with the first-type application mark to the shared directory, and obtaining the display reference data in the shared directory for the application with the second-type application mark.

In some embodiments, an application, when opened, may be set with an application mark. An application selected as the main application to be displayed in the main scene may be set with the first-type application mark, and an application opened to be displayed in the target window may be set with the second-type application mark. Whether an application is an application independently displayed in full screen or an application displayed in the target window is determined according to a mark. When it is detected that there is an application marked with the second-type application mark, the display reference data in the main scene is saved to the shared directory. When application marked with the second-type application mark is not detected, the display reference data in the main scene may not be saved to the shared directory.

In some embodiments of the present disclosure, the display method further includes: in response to a first operation event, moving a target object displayed in the target window to the main scene for loading and displaying; or in response to a second operation event, moving a target object displayed in the main scene to the target window for loading and displaying.

In some embodiments, objects in different applications may be moved across the applications. In the related art, an object in an application can only be displayed and interact in this application. In some embodiments of the present disclosure, the target object may be any object in the main scene or the target window. With the data management manner of the shared memory, the object in the main scene may be moved into the application scene of the second application in the target window, or the object in the application scene of the second application in the target window may be moved into the main window. Object interaction across applications is realized.

In some embodiments of the present disclosure, the display method further includes: displaying a controller and a ray emitted by the controller in the main scene, the controller is not displayed in the target window; and in response to the ray being emitted to the target window, truncating the ray in the main scene at the target window, and displaying an extended segment of the ray along an extension direction of the ray in the target window, the extended segment of the ray is capable of operating, in the target window, an object displayed in the target window.

In some embodiments, the controller may be a handle. The controller is located in the main scene. The controller may be displayed in the main scene and not displayed in the target window. The position of the ray emitted by the controller is shared to (the second application in) the target window. When the ray emitted by the controller hits the target window, the ray in the main scene and the extended segment of the ray in the target window for a straight line. The ray in the main scene may be truncated at the target window, and does not penetrate through the target window. That is, one part of the ray is located in the main scene, and the other part of the ray is located in the target window. Interaction with interactive elements such as interfaces, objects, and controls in the main scene and the target window can be achieved with the ray and the extended ray. For the current user, what is seen by the current user is that the interactive elements in the main scene can be controlled by means of the ray, and since the information of the ray in the main scene is shared to the target window and the extended segment of the ray in the application scene of the second application is displayed in the target window, the current user may also control the interactive elements in the target window by means of the ray, bringing convenience for the user.

In some embodiments of the present disclosure, the second application is displayed in the target window in a global display manner or a partial display manner; when the second application is displayed in the target window in the global display manner, an eyebuffer image of the second application is completely displayed in the target window; and when the second application is displayed in the target window in the partial display manner, part of the eyebuffer image of the second application is displayed in the target window.

In some embodiments, when global display is adopted, the eyebuffer image of the second application is entirely embedded in the target window. At this point, the image is complete, but the content may be zoomed out according to the size of the target window. A distance of a rendering camera used by the second application to the target window has a proportion constraint. The width and height (oW, oH) of the target window define a near clip plane of the rendering camera of the second application. The field of view (FOV) of the second application is a FOV (fovW, fovH) within the application, which is generally the same with the system. The distance of the rendering camera of the second application may be backward deduced according to the trigonometric function formula (tan (fovH/2)=oH/2/distance). The rendering camera in the second application is located in the connecting line of the camera in the main scene and the center point of the target window, and the target window is always perpendicular to the orientation of the camera of the main scene. The viewpoint direction of a rendering camera of a target application and the target window may change synchronously with the movement and rotation of the current user so that the user can view the application scene in the target window in all directions. When partial display is adopted, a size of an image cached by the eyebuffer of the second application is usually the same as a size of an eyebuffer image of the main scene, but a rendering space of the corresponding size may be clipped according to the width, height, and position of the target window. The rendering space may control display in combination with the size of the object to be displayed and rendered in the target window and the width and height of the target window. For example, if there is a flowerpot in the application scene, the whole flowerpot, rather than half of the flowerpot, is clipped. This manner is suitable for rendering and displaying of an independent display model, or may be used for displaying an object in a zooming manner.

In some embodiments of the present disclosure, multi-application display in the virtual reality world is realized based on the main scene in combination with the target window. A 3D interaction effect between the first application and the second application is achieved by sharing the display reference data such as the pose data. By sharing the memory, an object in an auxiliary scene is extracted into the main scene for displaying.

Some embodiments of the present disclosure further provide a display apparatus based on virtual reality, including:
a display unit configured to display a main scene in a three-dimensional virtual reality world, and display a target window in the main scene, the main scene is an application scene of a first application displayed in full screen, an application scene of a second application is displayed in the target window, and the first application and the second application are different; and
a control unit configured to obtain display reference data in the main scene, and share the display reference data in the main scene for the second application;
the control unit is further configured to control an application scene viewpoint of the main scene and an application scene viewpoint of the target window to be both consistent with a viewpoint of a current user according to the display reference data in the main scene.

In some embodiments, the display reference data in the main scene includes one or more selected from a group consisting of a camera pose in the main scene, a controller pose in the main scene, and a current user pose.

In some embodiments, obtaining the display reference data in the main scene and sharing the display reference data in the main scene for the second application include: saving the display reference data in the main scene to a shared directory, and obtaining the display reference data in the main scene for the second application from the shared directory.

In some embodiments, obtaining the display reference data in the main scene for the second application from the shared directory includes:
obtaining, by a runtime layer, the display reference data in the main scene from the shared directory, and replacing display reference data of the second application with the display reference data in the main scene.

In some embodiments, an application displayed in full screen has a first-type application mark, and an application displayed in the target window has a second-type application mark; and
saving the display reference data in the main scene to the shared directory, and sharing the display reference data in the main scene for the second application include: in response to presence of an application with the second-type application mark, saving display reference data of an application with the first-type application mark to the shared directory, and obtaining the display reference data in the shared directory for the application with the second-type application mark.

In some embodiments, the control unit is further configured to: in response to a first operation event, move a target object displayed in the target window to the main scene for loading and displaying; or in response to a second operation event, move a target object displayed in the main scene to the target window for loading and displaying.

In some embodiments, the first application of the main scene and the second application of the target window share a memory; and data of the target object is stored in the shared memory.

In some embodiments, a controller and a ray emitted by the controller are displayed in the main scene, and the controller is not displayed in the target window; and

in response to the ray being emitted to the target window, the ray in the main scene is truncated at the target window, and an extended segment of the ray is displayed along an extension direction of the ray in the target window, the extended segment of the ray is capable of operating, in the target window, an object displayed in the target window.

In some embodiments, the second application is displayed in the target window in a global display manner or a partial display manner;
when the second application is displayed in the target window in the global display manner, an eyebuffer image of the second application is completely displayed in the target window; and
when the second application is displayed in the target window in the partial display manner, part of the eyebuffer image of the second application is displayed in the target window.

For the apparatus embodiments, since they substantially correspond to the method embodiments, they are sufficient to refer to a part of the description of the method embodiments where relevant. The apparatus embodiments described above are merely exemplary, in which the modules illustrated as separate modules may be or may not be separated. Some or all of the modules may be selected based on actual needs to achieve the objectives of the solutions of the embodiments. Those of ordinary skill in the art can understand and implement the present disclosure without creative effort.

The method and apparatus of the present disclosure have been described above based on embodiments and application examples. Moreover, the present disclosure further provides an electronic device and a computer-readable storage medium, which are described below.

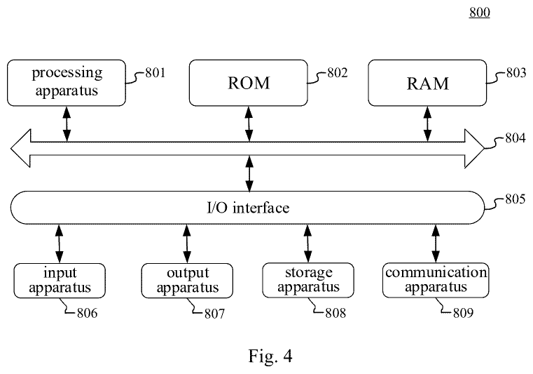

Referring to FIG. 4, FIG. 4 illustrates a schematic structural diagram of an electronic device (e.g. terminal device or server) 800 suitable for implementing some embodiments of the present disclosure. The electronic devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), a wearable electronic device or the like, and fixed terminals such as a digital TV, a desktop computer, or the like. The electronic device illustrated in FIG. 4 is merely an example, and should not pose any limitation to the functions and the range of use of the embodiments of the present disclosure.

The electronic device 800 may include a processing apparatus 801 (e.g., a central processing unit, a graphics processing unit, etc.), which can perform various suitable actions and processing according to a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are interconnected by means of a bus 804. An input/output (I/O) interface 805 is also connected to the bus 804.

Usually, the following apparatus may be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a loudspeaker, a vibrator, or the like; a storage apparatus 808 including, for example, a magnetic tape, a hard disk, or the like; and a communication apparatus 809. The communication apparatus 809 may allow the electronic device 800 to be in wireless or wired communication with other devices to exchange data. While FIG. 4 illustrates the electronic device 800 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 809 and installed, or may be installed from the storage apparatus 808, or may be installed from the ROM 802. When the computer program is executed by the processing apparatus 801, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that may be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local region network (LAN), a wide region network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the above-mentioned method of the present disclosure.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local region network (LAN) or a wide region network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, may be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, a display method based on virtual reality is provided, which includes: displaying a main scene in a three-dimensional virtual reality world and displaying a target window in the main scene, the main scene is an application scene of a first application displayed in full screen, an application scene of a second application is displayed in the target window, and the first application and the second application are different;
obtaining display reference data in the main scene and sharing the display reference data in the main scene for the second application; and
controlling an application scene viewpoint of the main scene and an application scene viewpoint of the target window to be both consistent with a viewpoint of a current user according to the display reference data in the main scene.

According to one or more embodiments of the present disclosure, a display method based on virtual reality is provided, the display reference data in the main scene includes one or more selected from a group consisting of a camera pose in the main scene, a controller pose in the main scene, and a current user pose.

According to one or more embodiments of the present disclosure, a display method based on virtual reality is provided, obtaining the display reference data in the main scene and sharing the display reference data in the main scene for the second application include: saving the display reference data in the main scene to a shared directory, and obtaining the display reference data in the main scene for the second application from the shared directory.

According to one or more embodiments of the present disclosure, a display method based on virtual reality is provided, obtaining the display reference data in the main scene for the second application from the shared directory includes:
obtaining, by a runtime layer, the display reference data in the main scene from the shared directory, and replacing display reference data of the second application with the display reference data in the main scene.

According to one or more embodiments of the present disclosure, a display method based on virtual reality is provided, an application displayed in full screen has a first-type application mark, and an application displayed in the target window has a second-type application mark; and
saving the display reference data in the main scene to the shared directory, and sharing the display reference data in the main scene for the second application, include: in response to presence of an application with the second-type application mark, saving display reference data of an application with the first-type application mark to the shared directory, and obtaining the display reference data in the shared directory for the application with the second-type application mark.

According to one or more embodiments of the present disclosure, a display method based on virtual reality is provided, the method further includes:
in response to a first operation event, moving a target object displayed in the target window to the main scene for loading and displaying; or
in response to a second operation event, moving a target object displayed in the main scene to the target window for loading and displaying.

According to one or more embodiments of the present disclosure, a display method based on virtual reality is provided, the first application of the main scene and the second application of the target window share a memory; and data of the target object is stored in the shared memory.

According to one or more embodiments of the present disclosure, a display method based on virtual reality is provided, the method further includes:
displaying a controller and a ray emitted by the controller in the main scene, the controller is not displayed in the target window; and
in response to the ray being emitted to the target window, truncating the ray in the main scene at the target window, and displaying an extended segment of the ray along an extension direction of the ray in the target window, the extended segment of the ray is capable of operating, in the target window, an object displayed in the target window.

According to one or more embodiments of the present disclosure, a display method based on virtual reality is provided, the second application is displayed in the target window in a global display manner or a partial display manner;

in response to the second application being displayed in the target window in the global display manner, an eyebuffer image of the second application is completely displayed in the target window; and

in response to the second application being displayed in the target window in the partial display manner, part of the eyebuffer image of the second application is displayed in the target window.

According to one or more embodiments of the present disclosure, a display apparatus based on virtual reality is provided, which includes:
a display unit configured to display a main scene in a three-dimensional virtual reality world, and display a target window in the main scene, the main scene is an application scene of a first application displayed in full screen, an application scene of a second application is displayed in the target window, and the first application and the second application are different; and
a control unit configured to obtain display reference data in the main scene, and share the display reference data in the main scene for the second application;
the control unit is further configured to control an application scene viewpoint of the main scene and an application scene viewpoint of the target window to be both consistent with a viewpoint of a current user according to the display reference data in the main scene.

According to one or more embodiments of the present disclosure, an electronic device is provided, including: at least one memory and at least one processor;
the at least one memory is configured to store program codes, and the at least one processor is configured to call the program codes stored on the at least one memory to perform the above-mentioned method.

According to one or more embodiments of the present disclosure, a computer-readable storage medium is provided, configured to store program codes which, when run by a processor, cause the processor to perform the above-mentioned method.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A display method based on virtual reality, comprising:
displaying a main scene in a three-dimensional virtual reality world and displaying a target window in the main scene, wherein the main scene is an application scene of a first application displayed in full screen, an application scene of a second application is displayed in the target window, and the first application and the second application are different;
obtaining display reference data in the main scene and sharing the display reference data in the main scene for the second application; and
controlling an application scene viewpoint of the main scene and an application scene viewpoint of the target window to be both consistent with a viewpoint of a current user according to the display reference data in the main scene.

2. The display method according to claim 1, wherein the display reference data in the main scene comprises one or more selected from a group consisting of a camera pose in the main scene, a controller pose in the main scene, and a current user pose.

3. The display method according to claim 1, wherein obtaining the display reference data in the main scene and sharing the display reference data in the main scene for the second application comprise: saving the display reference data in the main scene to a shared directory, and obtaining the display reference data in the main scene for the second application from the shared directory.

4. The display method according to claim 3, wherein obtaining the display reference data in the main scene for the second application from the shared directory comprises:
obtaining, by a runtime layer, the display reference data in the main scene from the shared directory, and replacing display reference data of the second application with the display reference data in the main scene.

5. The display method according to claim 3, wherein,
an application displayed in full screen has a first-type application mark, and an application displayed in the target window has a second-type application mark; and
saving the display reference data in the main scene to the shared directory, and sharing the display reference data in the main scene for the second application, comprise: in response to presence of an application with the second-type application mark, saving display reference data of an application with the first-type application mark to the shared directory, and obtaining the display reference data in the shared directory for the application with the second-type application mark.

6. The display method according to claim 1, further comprising:
in response to a first operation event, moving a target object displayed in the target window to the main scene for loading and displaying; or
in response to a second operation event, moving a target object displayed in the main scene to the target window for loading and displaying.

7. The display method according to claim 6, wherein the first application of the main scene and the second application of the target window share a memory; and data of the target object is stored in the shared memory.

8. The display method according to claim 1, further comprising:
displaying a controller and a ray emitted by the controller in the main scene, wherein the controller is not displayed in the target window; and
in response to the ray being emitted to the target window, truncating the ray in the main scene at the target window, and displaying an extended segment of the ray along an extension direction of the ray in the target window, wherein the extended segment of the ray is capable of operating, in the target window, an object displayed in the target window.

9. The display method according to claim 1, wherein the second application is displayed in the target window in a global display manner or a partial display manner;
in response to the second application being displayed in the target window in the global display manner, an eyebuffer image of the second application is completely displayed in the target window; and
in response to the second application being displayed in the target window in the partial display manner, part of the eyebuffer image of the second application is displayed in the target window.

10. An electronic device, comprising:
at least one memory and at least one processor;
wherein the at least one memory is configured to store program codes, and the at least one processor is configured to call the program codes stored on the at least one memory to perform:
displaying a main scene in a three-dimensional virtual reality world and displaying a target window in the main scene, wherein the main scene is an application scene of a first application displayed in full screen, an application scene of a second application is displayed in the target window, and the first application and the second application are different;
obtaining display reference data in the main scene and sharing the display reference data in the main scene for the second application; and
controlling an application scene viewpoint of the main scene and an application scene viewpoint of the target window to be both consistent with a viewpoint of a current user according to the display reference data in the main scene.

11. The electronic device according to claim 10, wherein the display reference data in the main scene comprises one or more selected from a group consisting of a camera pose in the main scene, a controller pose in the main scene, and a current user pose.

12. The electronic device according to claim 10, wherein obtaining the display reference data in the main scene and sharing the display reference data in the main scene for the second application comprise: saving the display reference data in the main scene to a shared directory, and obtaining the display reference data in the main scene for the second application from the shared directory.

13. The electronic device according to claim 10, wherein the at least one processor is further configured to call the program codes stored on the at least one memory to perform:
in response to a first operation event, moving a target object displayed in the target window to the main scene for loading and displaying; or
in response to a second operation event, moving a target object displayed in the main scene to the target window for loading and displaying.

14. The electronic device according to claim 10, wherein the at least one processor is further configured to call the program codes stored on the at least one memory to perform:
displaying a controller and a ray emitted by the controller in the main scene, wherein the controller is not displayed in the target window; and
in response to the ray being emitted to the target window, truncating the ray in the main scene at the target window, and displaying an extended segment of the ray along an extension direction of the ray in the target window, wherein the extended segment of the ray is capable of operating, in the target window, an object displayed in the target window.

15. The electronic device according to claim 10, wherein the second application is displayed in the target window in a global display manner or a partial display manner;
in response to the second application being displayed in the target window in the global display manner, an eyebuffer image of the second application is completely displayed in the target window; and
in response to the second application being displayed in the target window in the partial display manner, part of the eyebuffer image of the second application is displayed in the target window.

16. A computer-readable storage medium, configured to store program codes which, when run by a processor, cause the processor to perform:
displaying a main scene in a three-dimensional virtual reality world and displaying a target window in the main scene, wherein the main scene is an application scene of a first application displayed in full screen, an application scene of a second application is displayed in the target window, and the first application and the second application are different;
obtaining display reference data in the main scene and sharing the display reference data in the main scene for the second application; and
controlling an application scene viewpoint of the main scene and an application scene viewpoint of the target window to be both consistent with a viewpoint of a current user according to the display reference data in the main scene.

17. The computer-readable storage medium according to claim 16, wherein the display reference data in the main scene comprises one or more selected from a group consisting of a camera pose in the main scene, a controller pose in the main scene, and a current user pose.

18. The computer-readable storage medium according to claim 16, wherein obtaining the display reference data in the main scene and sharing the display reference data in the main scene for the second application comprise: saving the display reference data in the main scene to a shared directory, and obtaining the display reference data in the main scene for the second application from the shared directory.

19. The computer-readable storage medium according to claim 16, wherein the program codes, when run by the processor, further cause the processor to perform:
in response to a first operation event, moving a target object displayed in the target window to the main scene for loading and displaying; or
in response to a second operation event, moving a target object displayed in the main scene to the target window for loading and displaying.

20. The computer-readable storage medium according to claim 16, wherein the program codes, when run by the processor, further cause the processor to perform:
displaying a controller and a ray emitted by the controller in the main scene, wherein the controller is not displayed in the target window; and
in response to the ray being emitted to the target window, truncating the ray in the main scene at the target window, and displaying an extended segment of the ray along an extension direction of the ray in the target window, wherein the extended segment of the ray is capable of operating, in the target window, an object displayed in the target window.
